(19) United States
(12) Patent Application Publication
(10) Pub. No.: US 2015/0009560 A1
(43) Pub. Date: Jan. 8, 2015

(54) STEREOSCOPIC DISPLAY DEVICE

(71) Applicant: Chunghwa Picture Tubes, Ltd., Taoyuan (TW)

(72) Inventors: Lun-Wei Kang, Taoyuan County (TW); Yu-Chi Tsai, Taoyuan County (TW)

(73) Assignee: Chunghwa Picture Tubes, Ltd., Taoyuan (TW)

(21) Appl. No.: 13/959,747

(22) Filed: Aug. 6, 2013

(30) Foreign Application Priority Data
Jul. 2, 2013 (TW) 102123662

(51) Int. Cl. G02B 27/22

(52) U.S. Cl. CPC G02B 27/2214
USPC 359/463

(57) ABSTRACT

A stereoscopic display device includes a display panel, a first lens array and a second lens array. The display panel has a display surface. The display panel includes a plurality of sub-pixels arranged in an array. The first lens array is disposed on the display surface of the display panel and is a one-dimension lens array. The first lens array includes a plurality of first semi-cylindrical lens extending along a first direction. The first semi-cylindrical lens has a first refractive index. The second lens array is disposed on the first lens array and is a one-dimension lens array. The second lens array includes a plurality of second semi-cylindrical lens extending along a second direction. The second semi-cylindrical lens has a second refractive index. The first direction is not parallel to the second direction.

### BACKGROUND OF THE INVENTION

1. Field of the Invention

The present invention relates to a stereoscopic display device, and more particularly, to a naked eye type stereoscopic display device.

2. Description of the Prior Art

Display related technologies have progressed in recent years; stereoscopic display technologies and related applications have also developed flourishingly. The principle of the stereoscopic display technology includes delivering different images respectively to a left eye and a right eye of a viewer to give to the viewer a feeling of gradation and depth in the images, thereby generating the stereoscopic effect in the cerebrum of the viewer by analyzing and overlapping the images received separately by the left eye and the right eye.

The stereoscopic display device of the lenticular lens type doesn't suffer the brightness loss severely and its cost is lower. However, because the conventional stereoscopic display device of the lenticular lens type employs only one single one-dimension lens array, lens convergence only happens in the direction perpendicular to the lenticular lens. To be more specifically, the light rays carrying the display information bend toward specific directions respectively and thus are guided toward the left eye and the right eye of the viewer. As a result, the light rays are converged only in the direction perpendicular to the stereoscopic display device of the lenticular lens type. Accordingly, the viewer cannot operate the conventional stereoscopic display device under both the portrait display mode and landscape display mode.

### SUMMARY OF THE INVENTION

It is one of the objectives of the invention to provide a stereoscopic display device, which provides both the portrait display mode and landscape display mode.

The stereoscopic display device includes a display panel, a first lens array and a second lens array. The display panel has a display surface. The display panel includes a plurality of sub-pixels arranged in an array. The first lens array is disposed on the display surface of the display panel and is a one-dimension lens array. The first lens array includes a plurality of first semi-cylindrical lens extending along a first direction. The first lens array has a first refractive index. The second lens array is disposed on the first lens array and is a one-dimension lens array. The second lens array includes a plurality of second semi-cylindrical lens extending along a second direction. The second lens array has a second refractive index. The first direction is nonparallel to the second direction.

Because the stereoscopic display device includes the first lens array and the second lens array, the lens specifications for the portrait and landscape display modes can be designed separately so as to optimize the display quality of both the portrait and landscape display modes and provide more geometric parameters to be adjusted. Besides, because the first lens array and the second lens array are one-dimension lens arrays, the first lens array and the second lens array can be respectively formed by conventional fabrication approaches for a one-dimension lens array. By this means, not only the fabrication process is simplified but the optical geometric parameters of the first lens array and the second lens array can be precisely controlled to improve optical effects as well. Moreover, the cost is reduced and the light output efficiency is enhanced.

### BRIEF DESCRIPTION OF THE DRAWINGS

FIG. 1 is a schematic diagram illustrating a stereoscopic display device according to a first embodiment of the present invention.

FIG. 2 is a top-view schematic diagram illustrating the stereoscopic display device according to the first embodiment of the present invention.

FIG. 3 is a cross-sectional view diagram taken along a cross-sectional line AA′ in FIG. 2.

FIG. 4 is a cross-sectional view diagram taken along a cross-sectional line BB′ in FIG. 2.

FIG. 5 is a schematic diagram illustrating the relation between the relative brightness and the viewing angle of the stereoscopic display device.

FIG. 6 is a schematic diagram illustrating the relation between the crosstalk and the viewing angle of the stereoscopic display device designed according to the first embodiment of the present invention.

FIG. 7 is a top-view schematic diagram illustrating the stereoscopic display device according to a first variant of the first embodiment of the present invention.

FIG. 8 is a cross-sectional view diagram taken along a cross-sectional line CC′ in FIG. 7.

FIG. 9 is a cross-sectional view diagram taken along a cross-sectional line DD′ in FIG. 7.

FIG. 10 is a schematic diagram illustrating a stereoscopic display device according to a second variant of the first embodiment of the present invention.

FIG. 11 is a schematic diagram illustrating a stereoscopic display device according to a third variant of the first embodiment of the present invention.

FIG. 12 is a schematic diagram illustrating a stereoscopic display device according to a second embodiment of the present invention.

FIG. 13 is a schematic diagram illustrating a stereoscopic display device according to a third embodiment of the present invention.

FIG. 14 is a schematic diagram illustrating a stereoscopic display device according to a fourth embodiment of the present invention.

### DETAILED DESCRIPTION

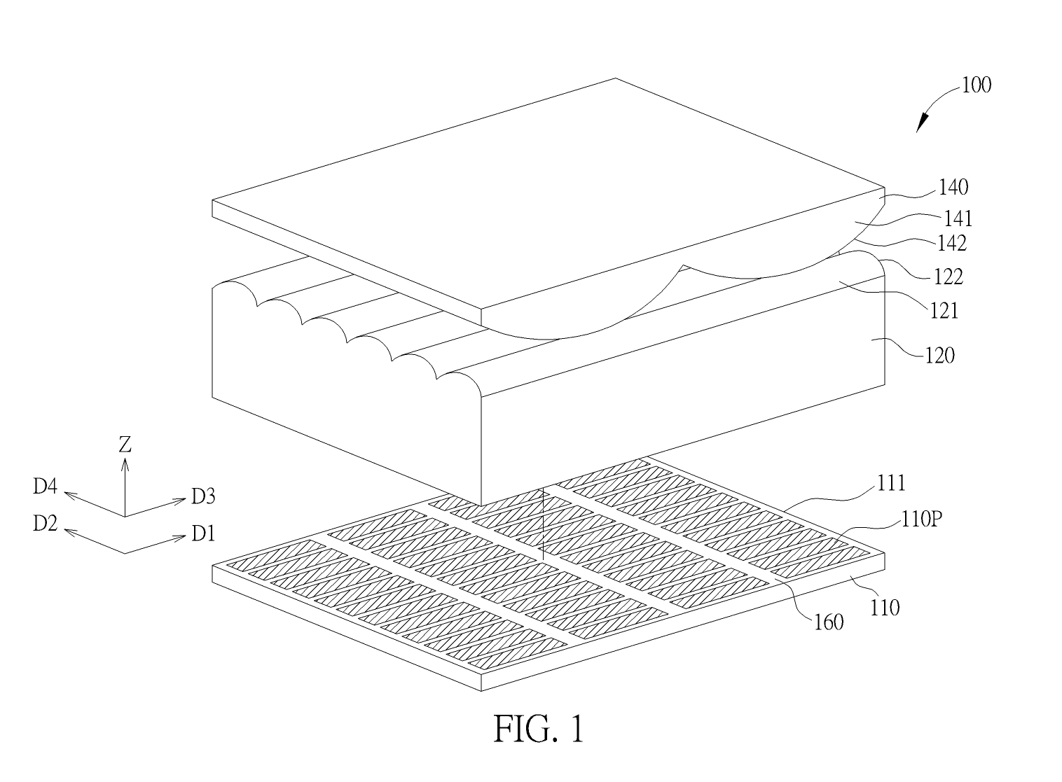

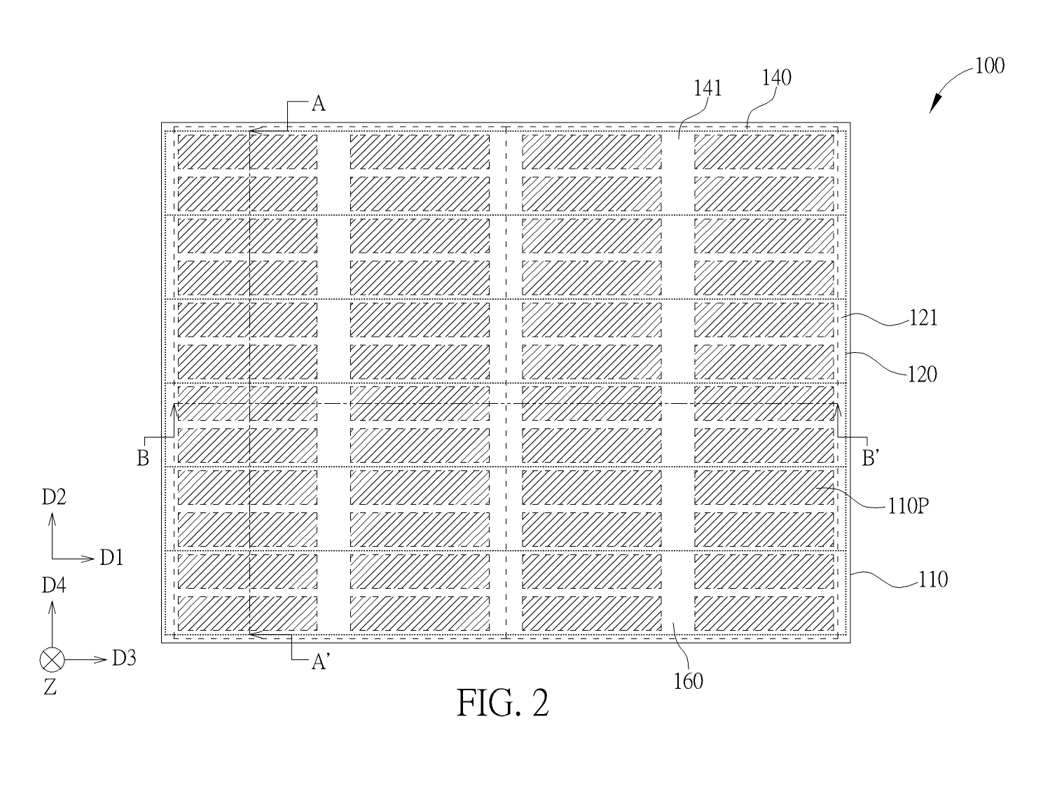

Please refer to FIGS. 1 and 2. FIG. 1 is a schematic diagram illustrating a stereoscopic display device according to a first embodiment of the present invention. FIG. 2 is a top-view schematic diagram illustrating the stereoscopic display device according to the first embodiment of the present invention. A stereoscopic display device 100 is a naked eye type stereoscopic display device. The stereoscopic display device 100 comprises a display panel 110, a first lens array 120 and a second lens array 140. The display panel 110 has a display surface 111. The display panel 110 comprises a plurality of sub-pixels 110P arranged in an array and a spacing 160. The sub-pixels 110P may include the sub-pixels to present images of different colors, such as red sub-pixels, green sub-pixels and blue sub-pixels, but not limited thereto. A portion of the sub-pixels 110P provides a left eye image, and the other portion of the sub-pixels 110P provides a right eye image. The left eye image and right eye image are respectively guided toward the left eye and the right eye of the viewer to form a stereoscopic image. There is the spacing 160 between any two of the sub-pixels 110P adjacent to each other. The spacing 160 does not provide any pixel image information. In other words, the spacing 160 may be regarded as non-pixel spacing. The display panel 110 may be any type of display panel, such as a liquid crystal display panel, an organic light-emitting diode (OLED) display panel, an electro-wetting display panel, an e-ink display panel, a plasma the display panel or a field emission display (FED) panel, but not limited thereto. The first lens array 120 is disposed on the display surface 111 of the display panel 110 and is a one-dimension lens array. The second lens array 140 is disposed on the first lens array 120 and is a one-dimension lens array. The first lens array 120 has a first refractive index n1. The second lens array 140 has a second refractive index n2. The first refractive index n1 may or may not equal the second refractive index n2. The material of the first lens array 120 and the second lens array 140 comprises transmitting materials and may be organic transmitting materials, inorganic transmitting materials or inorganic/organic hybrid transmitting materials, the material of the first lens array 120 and the second lens array 140 may comprise polymer transmitting materials, such as Methylmethacrylate Styrene (MS), Polycarbonate (PC), polymethylmethacrylate (PMMA), Polystyrene (PS), polyethylene terephthalate (PET) or mixtures thereof, but not limited thereto. The first lens array 120 comprises a plurality of first semi-cylindrical lenses 121 extending along a first direction D1. The second lens array 140 comprises a plurality of second semi-cylindrical lenses 141 extending along a second direction D2. The first direction D1 is nonparallel to the second direction D2—that is to say, there is a non-zero angle between the first direction D1 and the second direction D2. As shown in FIG. 2, preferably, the first direction D1 is substantially perpendicular to the second direction D2 so as to optimize the display quality of the portrait and landscape display modes, but not limited thereto, the first semi-cylindrical lenses 121 face the second lens array 140. The second semi-cylindrical lenses 141 face the first lens array 120. In other words, the first semi-cylindrical lenses 121 are disposed on a side of the first lens array 120. The second semi-cylindrical lenses 141 are disposed on a side of the second lens array 140. However, the present invention is not limited to this. The first semi-cylindrical lenses 121 may be disposed on both sides of the first lens array 120, and the second semi-cylindrical lenses 141 may be disposed on both sides of the second lens array 140. Each of the first semi-cylindrical lenses 121 is a lenticular lens formed by extending a first arcuate contour 122 along the first direction D1. Similarly, each of the second semi-cylindrical lenses 141 is a lenticular lens formed by extending a second arcuate contour 142 along the second direction D2. The first arcuate contour 122 and the second arcuate contour 142 are simple circular curve and respectively have a first radius of curvature and a second radius of curvature. In other words, the first semi-cylindrical lenses 121 and the second semi-cylindrical lenses 141 may be lenticular lenses of simple circular curve, but not limited thereto. For example, the first arcuate contour 122 and the second arcuate contour 142 may also be non-circular curve. In other words, the first semi-cylindrical lenses 121 and the second semi-cylindrical lenses 141 may also be respectively a lenticular lens with a cross-section of a non-circular curve, which approximates to a circular curve. Besides, because the first lens array 120 and the second lens array 140 are one-dimension lens arrays, the first lens array 120 and the second lens array 140 can be respectively formed by moving the machine tool (i.e., the cutting tool) with the shape of the first arcuate contour 122 or the second arcuate contour 142 along a specific path to simplify the fabrication process and reduce the cost. The first lens array 120 and the second lens array 140 may be formed by an injection molding process or other kinds of processes.

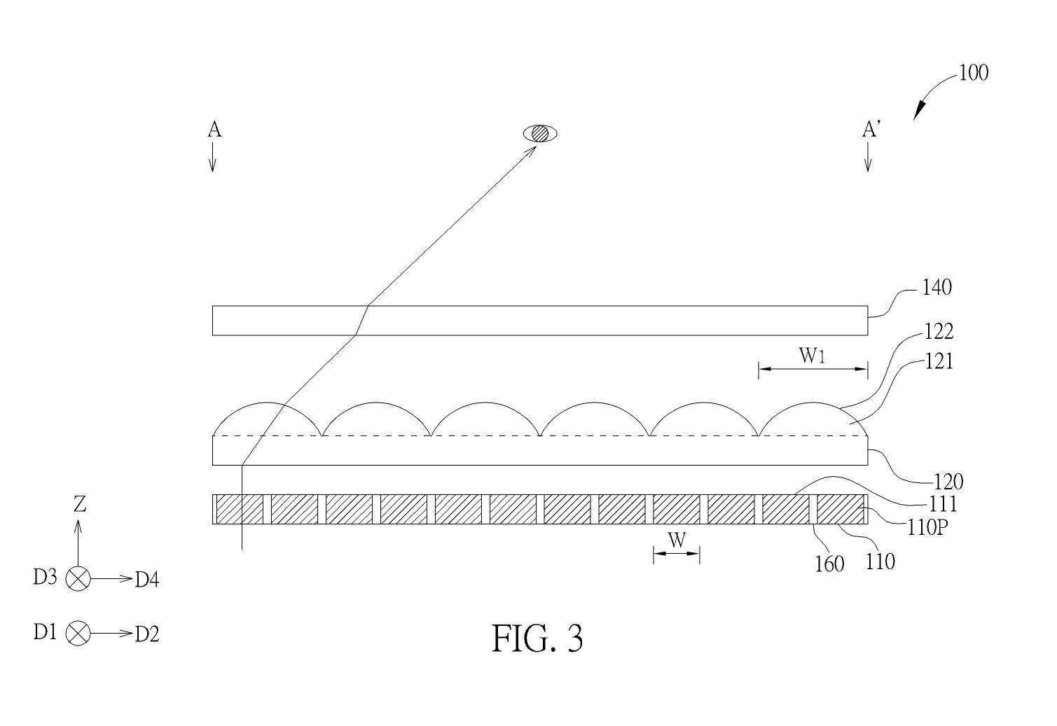

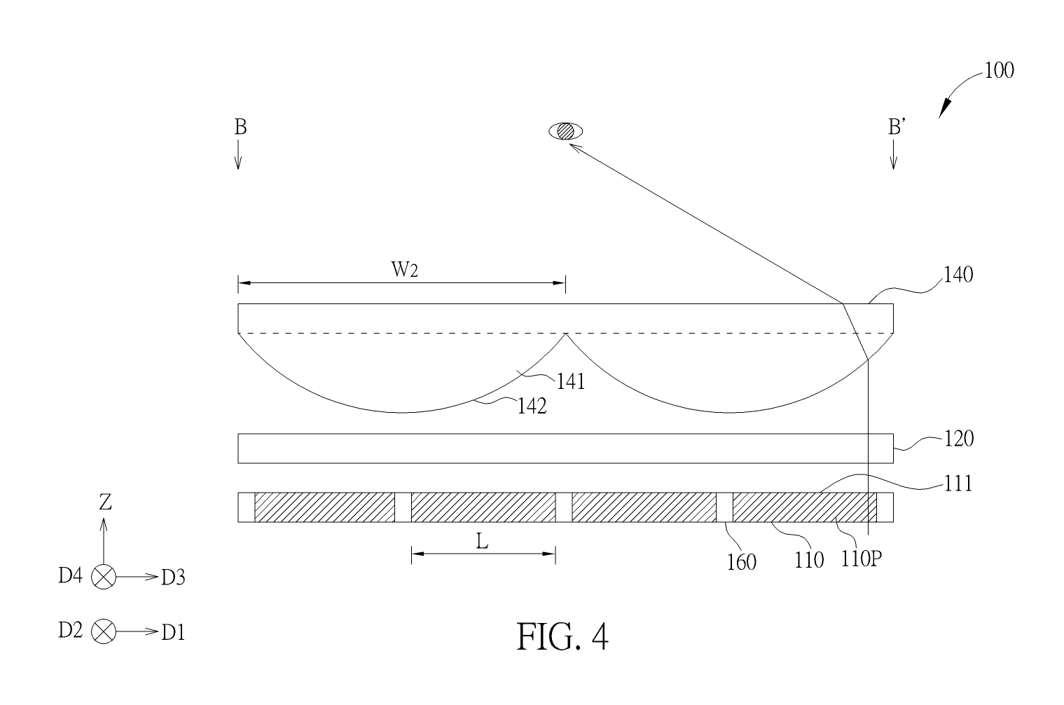

Please refer to FIGS. 3 and 4. FIG. 3 is a cross-sectional view diagram taken along a cross-sectional line AA′ in FIG. 2. FIG. 4 is a cross-sectional view diagram taken along a cross-sectional line BB′ in FIG. 2. As shown in FIG. 3, after the light rays carrying the right eye display information are emitted from the sub-pixels for the right eye images, the light rays penetrate the first lens array 120. With the first semi-cylindrical lenses 121, the light rays subsequently bend toward specific directions respectively and thus are guided toward the right eye of the viewer. After passing through the second lens array 140, each of the light rays, which is refracted by the plane parallel cross-section of the second lens array 140, is parallel to its incident light ray but is shifted—that is, the so-called longitudinal shift. As a result, the light rays are eventually converged in the direction perpendicular to the first semi-cylindrical lenses 121. Similarly, after the light rays carrying the left eye display information are emitted from the sub-pixels for the left eye images, the light rays penetrate the first lens array 120. With the first semi-cylindrical lenses 121, the light rays subsequently bend toward specific directions respectively and thus are guided toward the left eye of the viewer. After passing through the second lens array 140, each of the light rays, which is refracted by the plane parallel cross-section of the second lens array 140, is parallel to its incident light ray but is shifted. As a result, the light rays are eventually converged in the direction perpendicular to the first semi-cylindrical lenses 121. As shown in FIG. 4, after the light rays carrying the right eye display information are emitted from the sub-pixels for the right eye images, the light rays penetrate the first lens array 120. Each of the light rays, which is refracted by the plane parallel cross-section of the first lens array 120, is parallel to its incident light ray but is shifted—that is, the so-called longitudinal shift. After passing through the second lens array 140, the light rays subsequently bend toward specific directions respectively and thus are guided toward the right eye of the viewer with the second semi-cylindrical lenses 141. As a result, the light rays are eventually converged in the direction perpendicular to the second semi-cylindrical lenses 141. Similarly, after the light rays carrying the left eye display information are emitted from the sub-pixels for the left eye images, the light rays penetrate the first lens array 120. Each of the light rays, which is refracted by the plane parallel cross-section of the first lens array 120, is parallel to its incident light ray but is shifted. After passing through the second lens array 140, the light rays subsequently bend toward specific directions respectively and thus are guided toward the left eye of the viewer with the second semi-cylindrical lenses 141. As a result, the light rays are eventually converged in the direction perpendicular to the second semi-cylindrical lenses 141. Accordingly, the first lens array 120 and the second lens array 140 meet the requirement of operating the stereoscopic display device 100 under both portrait and landscape display modes. With the first lens array 120 and the second lens array 140, the geometric parameters of the first lens array 120 and the second lens array 140 can be adjusted by individual so that the number of parameters increases. Therefore, the optimum viewing distance between the stereoscopic display device of the present invention and the viewer under both the portrait and landscape display modes is equal, and the optimum optical effects are achieved under both the portrait and landscape display modes. In other words, the stereoscopic display device of the present invention provides proper and identical optimum viewing distance for both the portrait and landscape display modes, so there is no need for the viewer to adjust the distance from the stereoscopic display device 100 when the viewer switches between the portrait display mode and the landscape display mode, thereby increasing ease in accessibility.

Each of the sub-pixels 110P is a rectangle sub-pixel. Each of the sub-pixels 110P has a length L along a third direction D3. Each of the sub-pixels 110P has a width W along a fourth direction D4. The third direction D3 is perpendicular to the fourth direction D4. Therefore, an array appearance is shown. As shown in FIG. 3, each of the first semi-cylindrical lenses 121 has a first width W₁. Similarly, as shown in FIG. 4, each of the second semi-cylindrical lenses 141 has a second width W₂. The first direction D1 is parallel to the third direction D3. The second direction D2 is parallel to the fourth direction D4. However, the present invention is not limited to this and there may be a non-zero angle between the first direction D1 and the third direction D3. Furthermore, the first width W₁ is at least more than twice the width W of the sub-pixels. The second width W₂ is at least more than twice the length L of the sub-pixels. For example, as shown in FIG. 3, the first semi-cylindrical lens 121 overlaps two of the sub-pixels 110P along a vertical projection direction Z. The first width W₁ of the first semi-cylindrical lenses 121 is about twice the width W of the sub-pixels 110P. As shown in FIG. 4, the second semi-cylindrical lens 141 overlaps two of the sub-pixels 110P along the vertical projection direction Z. The second width W₂ of the second semi-cylindrical lenses 141 is about twice the length L of the sub-pixels 110P. However, in a practical manufacturing process, the first width W₁ may not exactly be integer multiples of the pixel pitch, the distance between the centers of two adjacent sub-pixels 110P, but with a slightly difference. Therefore, in a cross-sectional view diagram taken along a cross-sectional line along the direction perpendicular to the third direction D3, the first semi-cylindrical lenses 121 may fully overlap two of the adjacent sub-pixels 110P in the center of the stereoscopic display device along the vertical projection direction Z but may not fully overlap two of the adjacent sub-pixels 110P at the periphery of the stereoscopic display device along the vertical projection direction Z. Similarly, in a practical manufacturing process, the second width W₂ may not exactly be integer multiples of the pixel pitch, the distance between the centers of two adjacent sub-pixels 110P, but with a slightly difference. Therefore, in a cross-sectional view diagram taken along a cross-sectional line along the direction perpendicular to the fourth direction D4, the second semi-cylindrical lenses 141 may fully overlap two of the adjacent sub-pixels 110P in the center of the stereoscopic display device along the vertical projection direction Z but may not fully overlap two of the adjacent sub-pixels 110P at the periphery of the stereoscopic display device along the vertical projection direction Z. However, the present invention is not limited to this—the first width W₁ may be greater than integer multiples of the width W of the sub-pixels, and the second width W₂ may be greater than integer multiples of the length L of the sub-pixels so as to provide the multi-view function. Furthermore, with the first lens array 120 and the second lens array 140, the stereoscopic display device is suitable for the sub-pixels 110P of all kinds of aspect ratios by adjusting the first width W₁ and the second width W₂, and the optimum viewing distance under both the portrait and landscape display modes for the viewer is equal.

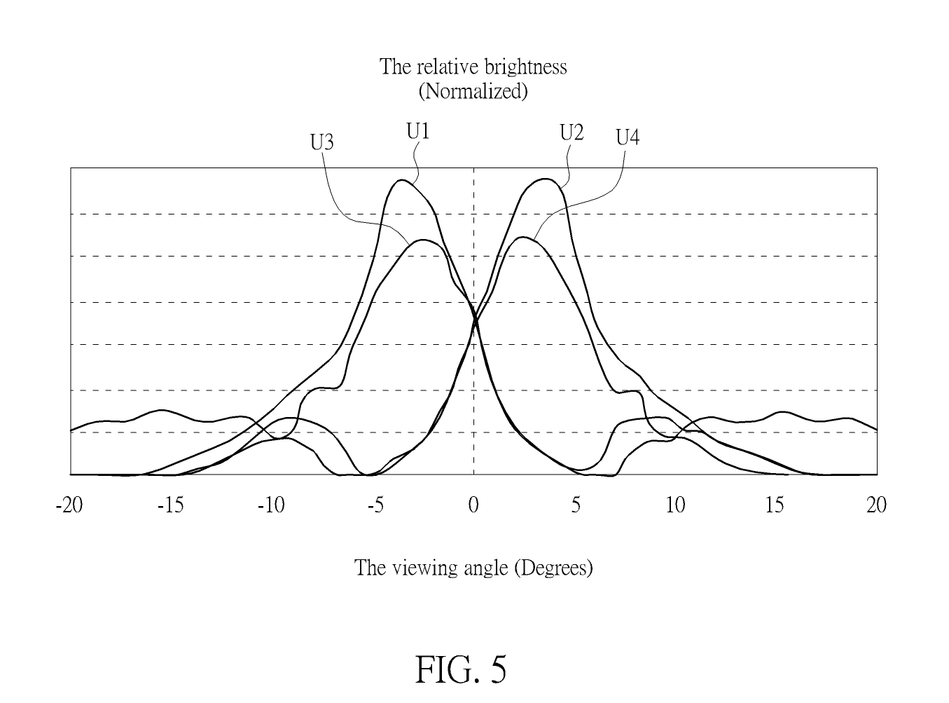

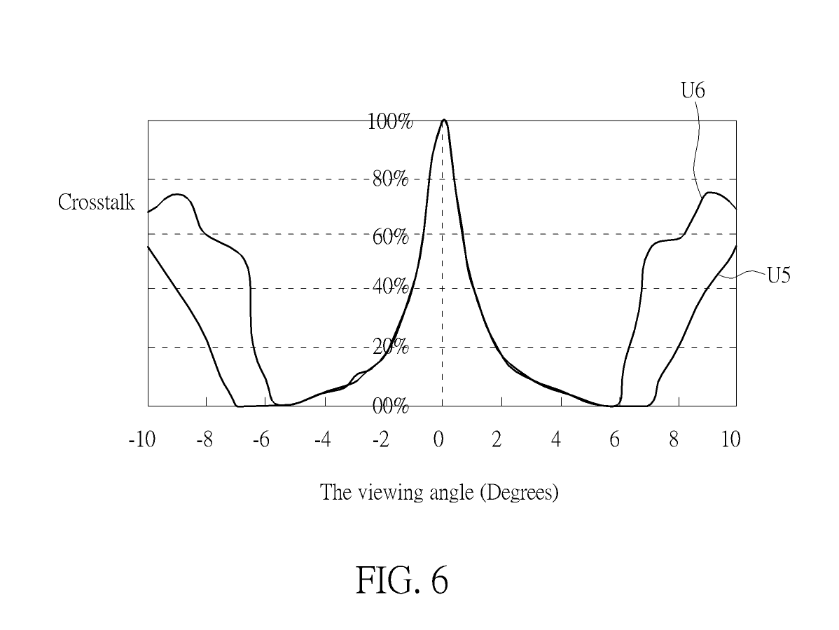

Please refer to FIGS. 5-6 and Table 1. Table 1 lists the appearance and material of the sub-pixels 110P, the first lens array 120 and the second lens array 140 in the first embodiment of the present invention. FIG. 5 is a schematic diagram illustrating the relation between the relative brightness and the viewing angle of the stereoscopic display device designed according to Table 1. As shown in FIG. 5, the first curve U1 represents the relation between the relative brightness and the viewing angle according to the left eye of the viewer under the portrait display mode. The second curve U2 represents the relation between the relative brightness and the viewing angle according to the right eye of the viewer under the portrait display mode. The third curve U3 represents the relation between the relative brightness and the viewing angle according to the left eye of the viewer under the landscape display mode. The fourth curve U4 represents the relation between the relative brightness and the viewing angle according to the right eye of the viewer under the landscape display mode. As shown in FIG. 5, because the viewing angle range of the higher relative brightness according to the left eye of the viewer under the landscape display mode substantially overlap the viewing angle range of the higher relative brightness according to the left eye of the viewer under the portrait display mode, and because the viewing angle range of the higher relative brightness according to the right eye of the viewer under the landscape display mode substantially overlap the viewing angle range of the higher relative brightness according to the right eye of the viewer under the portrait display mode, fine stereoscopic images are formed for both the portrait and the landscape display modes if the distance between the viewer and the stereoscopic display device is the optimum viewing distance, thereby increasing ease in accessibility. In other words, the performance under the portrait display mode and under the landscape display mode in the optimum viewing distance is almost the same. FIG. 6 is a schematic diagram illustrating the relation between the crosstalk and the viewing angle of the stereoscopic display device designed according to the first embodiment of the present invention. As shown in FIG. 6, the fifth curve U5 represents the relation between the crosstalk and the viewing angle under the portrait display mode. The sixth curve U6 represents the relation between the crosstalk and the viewing angle under the landscape display mode. As shown in FIG. 6, if the crosstalk under both the portrait and the landscape display modes is less than 15%, and if the viewing angle of the left eye is substantially in a range of −6 to −3 degrees and the viewing angle of the right eye is substantially in a range of 3 to 6 degrees, the optimum viewing distance between the stereoscopic display device 100 and the viewer is deduced to be substantially in a range of 31 to 62 cm from the inter pupillary distance. In other words, the optimum viewing distance between the stereoscopic display device of the present invention and the viewer under both the portrait and landscape display modes for the viewer is equal. In addition, the stereoscopic display device of the present invention provides proper and identical optimum viewing distance for both the portrait and landscape display modes, so there is no need for the viewer to adjust the distance from the stereoscopic display device 100 when the viewer switches between the portrait display mode and the landscape display mode, thereby increasing ease in accessibility. In general, the optimum viewing distance between the stereoscopic display device 100 and the viewer is substantially 46 cm. In this case, the stereoscopic display device in the first embodiment of the present invention provides a viewing angle range with the crosstalk less than 15%, thereby achieving the optimum display quality.

TABLE 1

| | | Value |
|---|---|---|
| The display panel | The width of the sub-pixel (along the | 37.6 |
| | fourth direction) (micrometers) | |
| | The length of the sub-pixel (along the | 112.8 |
| | third direction) (micrometers) | |
| | The width of the spacing (along the | 10 |
| | fourth direction) (micrometers) | |
| | The length of the spacing (along the | 30 |
| | third direction) (micrometers) | |
| The first lens array | The furthest distance from the surface | 345 |
| | of the sub-pixels (micrometers) | |
| | The first radius of curvature | 300 |
| | (micrometers) | |
| | The first refractive index | 1.57 |
| The second lens array | The furthest distance from the surface | 630 |
| | of the sub-pixels (micrometers) | |
| | The second radius of curvature | 680 |
| | (micrometers) | |
| | The second refractive index | 1.57 |

Stereoscopic display devices are not restricted to the preceding embodiments. Other embodiments or modifications will be detailed in the following description. In order to simplify and show the differences or modifications between the following embodiments and the above-mentioned embodiment, the same numerals denote the same components in the following description, and the similar parts are not detailed redundantly.

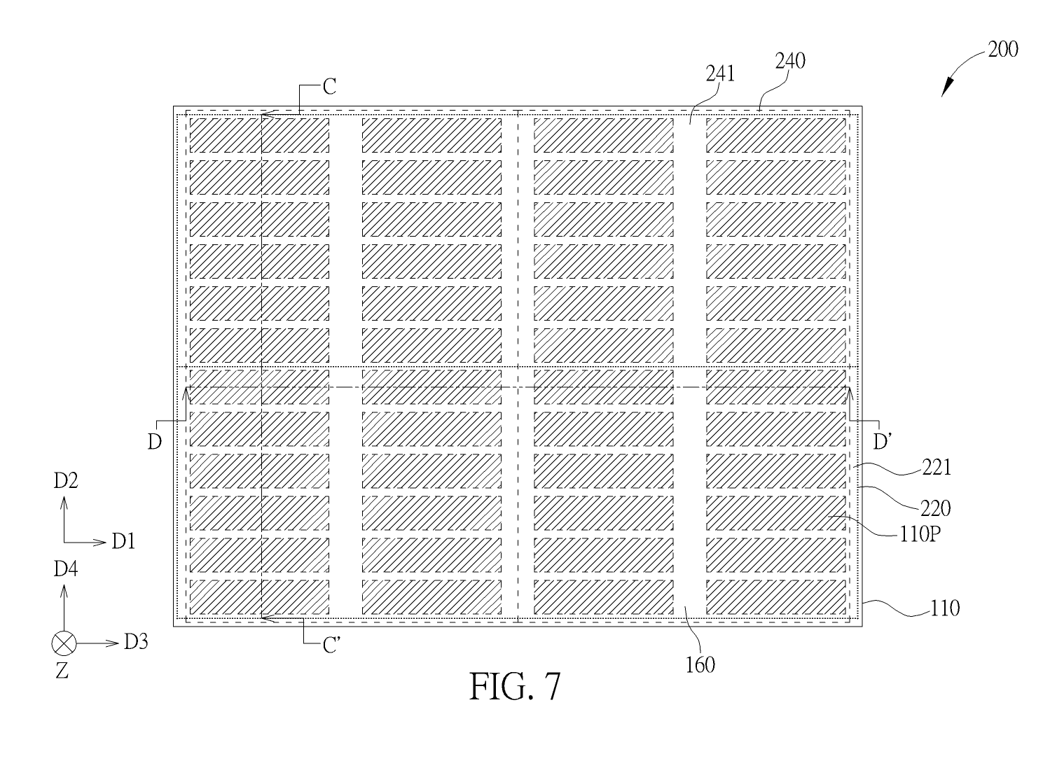

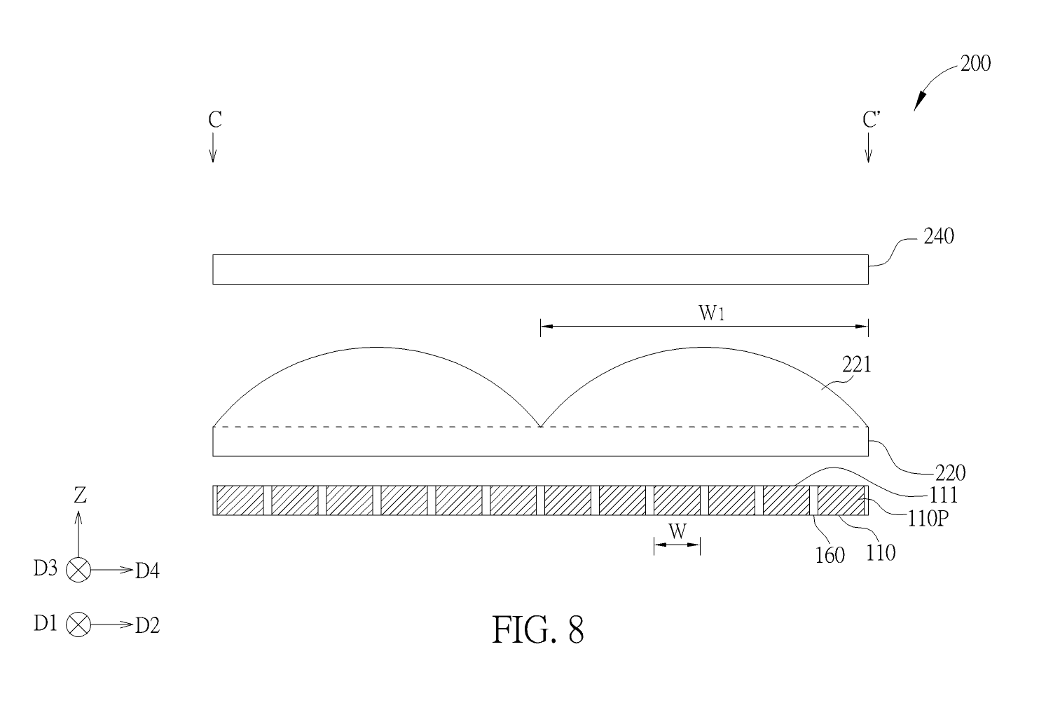

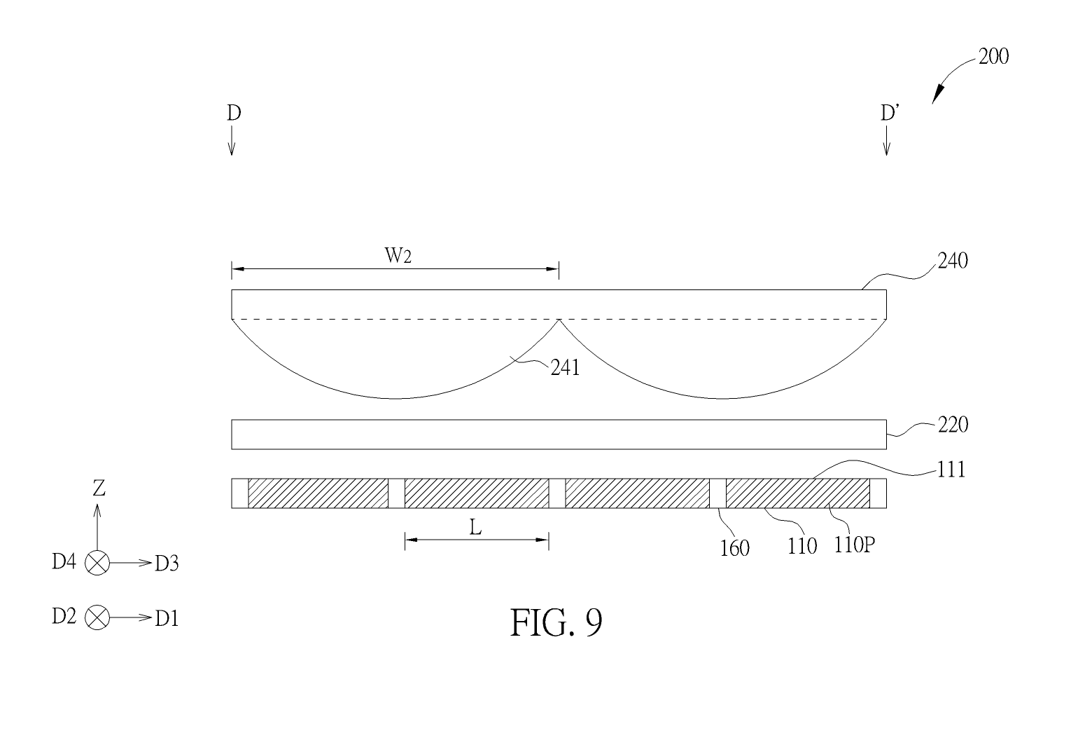

Please refer to FIGS. 7-9. FIG. 7 is a top-view schematic diagram illustrating the stereoscopic display device according to a first variant of the first embodiment of the present invention. FIG. 8 is a cross-sectional view diagram taken along a cross-sectional line CC′ in FIG. 7. FIG. 9 is a cross-sectional view diagram taken along a cross-sectional line DD′ in FIG. 7. As shown in FIG. 7, a stereoscopic display device 200 is provided in the first variant embodiment of the present invention. Compared with the stereoscopic display device 100 of the aforementioned first embodiment, the first width W₁ is at least more than six times the width W of the sub-pixels. The second width W₂ is at least more than twice the length L of the sub-pixels. For example, as shown in FIG. 8, the first semi-cylindrical lens 221 overlaps six of the sub-pixels 110P along the vertical projection direction Z. The first width W₁ of the first semi-cylindrical lenses 221 is about six times the width W of the sub-pixels 110P. As shown in FIG. 9, the second semi-cylindrical lens 241 overlaps two of the sub-pixels 110P along the vertical projection direction Z. The second width W₂ of the second semi-cylindrical lenses 241 is about twice the length L of the sub-pixels 110P. Therefore, the multi-view function can be provided. However, in a practical manufacturing process, the first width W₁ may not exactly be integer multiples of the pixel pitch, the distance between the centers of two adjacent sub-pixels 110P, but with a slightly difference. Therefore, in a cross-sectional view diagram taken along a cross-sectional line along the direction perpendicular to the third direction D3, the first semi-cylindrical lenses 221 may fully overlap six of the adjacent sub-pixels 110P in the center of the stereoscopic display device along the vertical projection direction Z but may not fully overlap six of the adjacent sub-pixels 110P at the periphery of the stereoscopic display device along the vertical projection direction Z. Similarly, in a practical manufacturing process, the second width W₂ may not exactly be integer multiples of the pixel pitch, the distance between the centers of two adjacent sub-pixels 110P, but with a slightly difference. Therefore, in a cross-sectional view diagram taken along a cross-sectional line along the direction perpendicular to the fourth direction D4, the second semi-cylindrical lenses 241 may fully overlap two of the adjacent sub-pixels 110P in the center of the stereoscopic display device along the vertical projection direction Z but may not fully overlap two of the adjacent sub-pixels 110P at the periphery of the stereoscopic display device along the vertical projection direction Z. Apart from the magnitude of the first width W₁ and the second width W₂ in the stereoscopic display device 200 of this embodiment, features, locations and material properties of other components are similar to those in the first embodiment detailed above and will not be redundantly described.

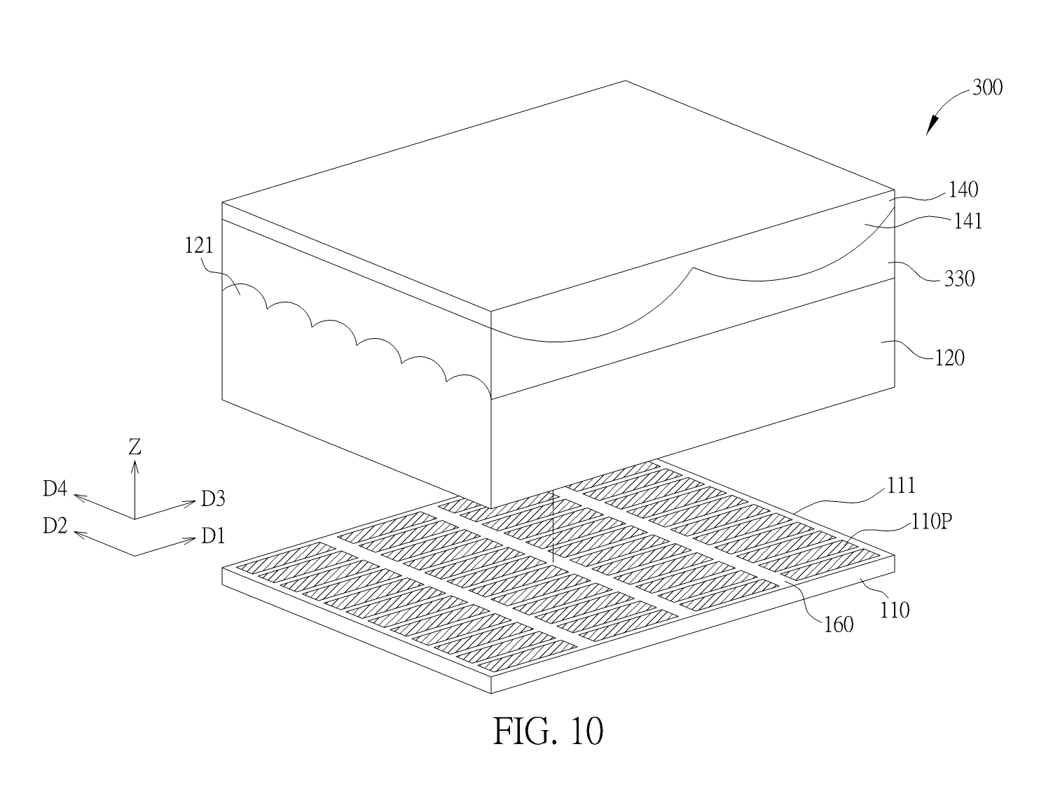

Please refer to FIG. 10. FIG. 10 is a schematic diagram illustrating a stereoscopic display device 300 according to a second variant of the first embodiment of the present invention. Compared with the stereoscopic display device 100 of the aforementioned first embodiment, there is a support material layer 330 between the first lens array 120 and the second lens array 140 so as to fix the distance between the first lens array 120 and the second lens array 140. The support material layer 330 has a third refractive index n3. Preferably, the third refractive index n3 is less than the first refractive index n1. The third refractive index n3 is less than the second refractive index n2. The support material layer 330 may be gas, such as air, or other transparent solid or liquid materials. Apart from the support material layer 330 disposed in the stereoscopic display device 300 of this embodiment, features, locations and material properties of other components are similar to those in the first embodiment detailed above and will not be redundantly described.

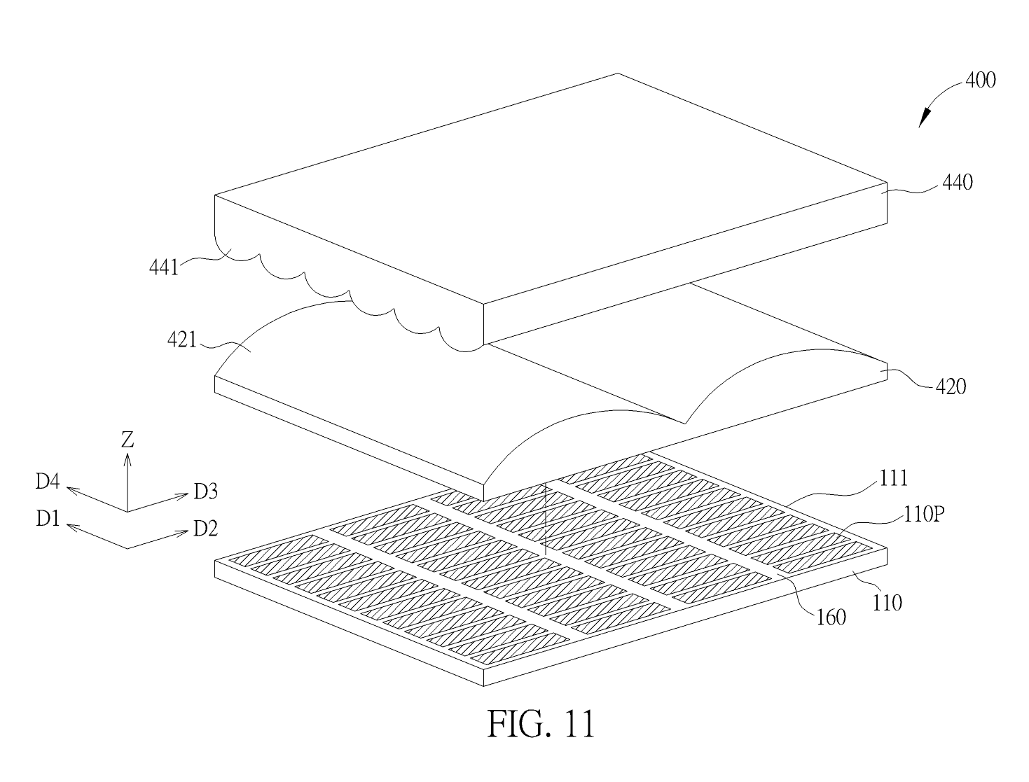

Please refer to FIG. 11. FIG. 11 is a schematic diagram illustrating a stereoscopic display device according to a third variant of the first embodiment of the present invention. As shown in FIG. 11, a stereoscopic display device 400 is provided in the third variant embodiment of the present invention. Compared with the stereoscopic display device 100 of the aforementioned first embodiment, the first direction D1 is parallel to the fourth direction D4, and the second direction D2 is parallel to the third direction D3. Apart from the arrangement of the first semi-cylindrical lenses 421 and the second semi-cylindrical lenses 441 in the stereoscopic display device 400 of this embodiment, features, locations and material properties of other components are similar to those in the first embodiment detailed above and will not be redundantly described.

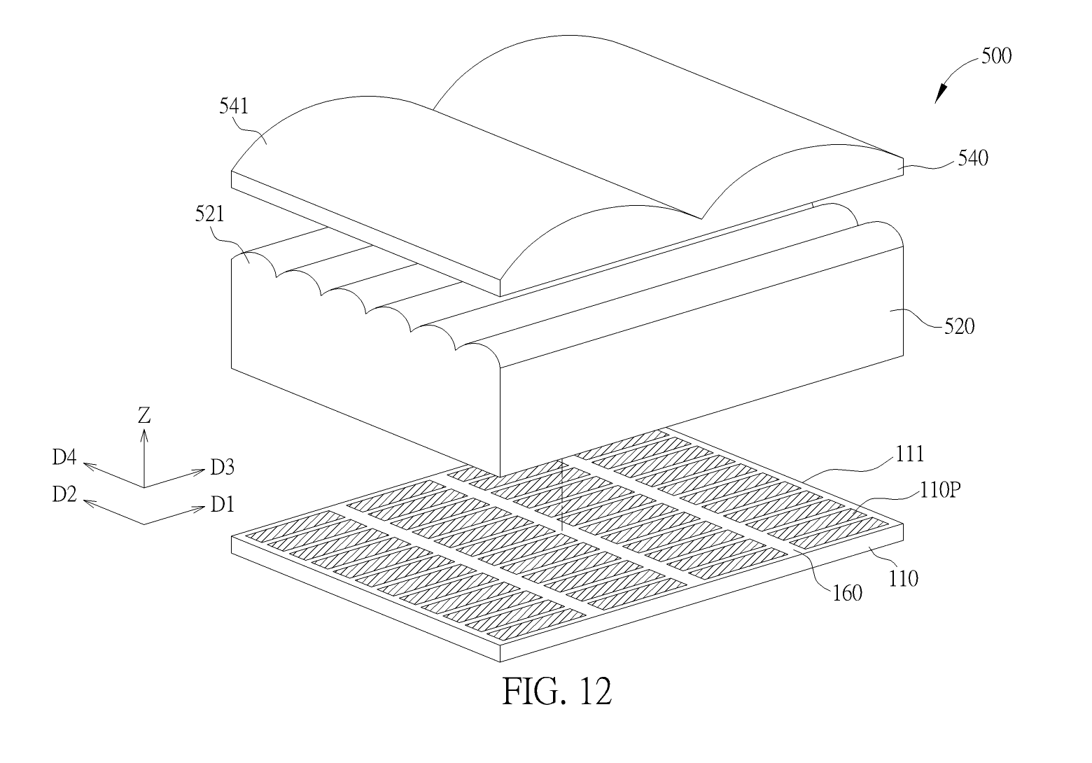

Please refer to FIG. 12. FIG. 12 is a schematic diagram illustrating a stereoscopic display device according to a second embodiment of the present invention. As shown in FIG. 12, a stereoscopic display device 500 is provided in the second embodiment of the present invention. Compared with the stereoscopic display device 100 of the aforementioned first embodiment, the first semi-cylindrical lenses 521 face the second lens array 540, and the second semi-cylindrical lenses 541 face the opposite direction from the first lens array 520. In other words, both the first semi-cylindrical lenses 521 and the second semi-cylindrical lenses 541 face the opposite direction from the display panel 110. Apart from the arrangement of the first semi-cylindrical lenses 521 and the second semi-cylindrical lenses 541 in the stereoscopic display device 500 of this embodiment, features, locations and material properties of other components are similar to those in the first embodiment detailed above and will not be redundantly described. It is worth noting that the stereoscopic display device 500 of the second embodiment has variant embodiments as the first embodiment has the first variant embodiment, the second variant embodiment and the third variant embodiment.

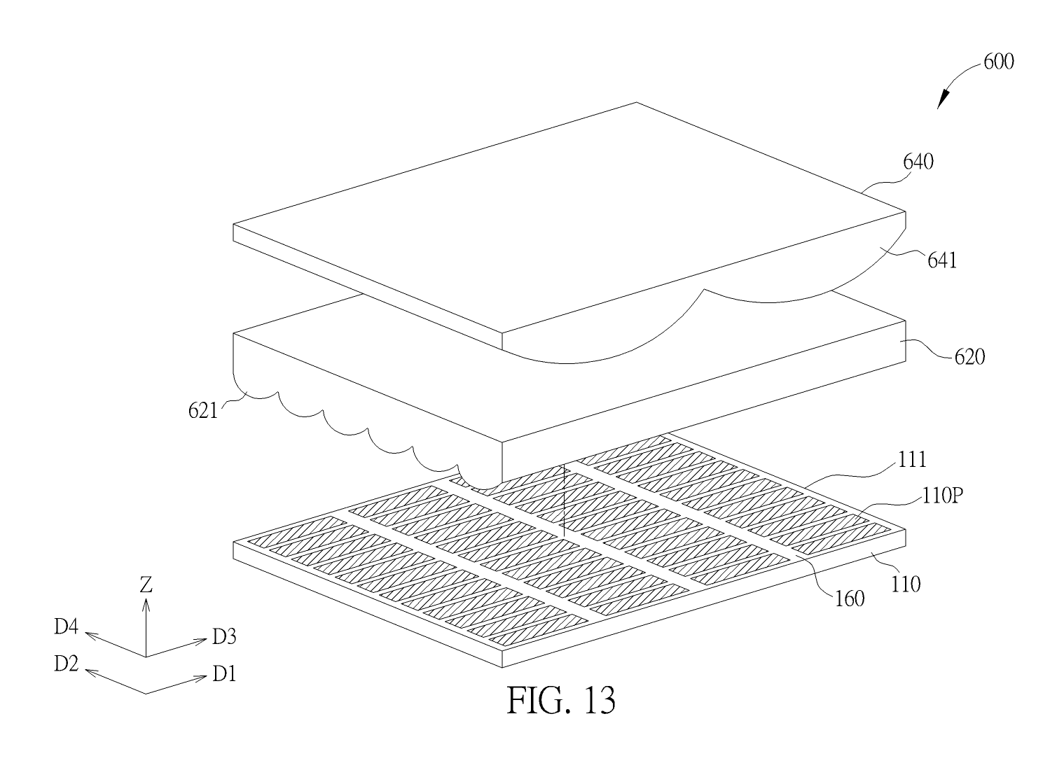

Please refer to FIG. 13. FIG. 13 is a schematic diagram illustrating a stereoscopic display device according to a third embodiment of the present invention. As shown in FIG. 13, a stereoscopic display device 600 is provided in the third embodiment of the present invention. Compared with the stereoscopic display device 100 of the aforementioned first embodiment, the first semi-cylindrical lenses 621 face the opposite direction from the second lens array 640, and the second semi-cylindrical lenses 641 face the first lens array 620. In other words, both the first semi-cylindrical lenses 621 and the second semi-cylindrical lenses 641 face the display panel 110. Apart from the arrangement of the first semi-cylindrical lenses 621 and the second semi-cylindrical lenses 641 in the stereoscopic display device 600 of this embodiment, features, locations and material properties of other components are similar to those in the first embodiment detailed above and will not be redundantly described. It is worth noting that the stereoscopic display device 600 of the third embodiment has variant embodiments as the first embodiment has the first variant embodiment, the second variant embodiment and the third variant embodiment.

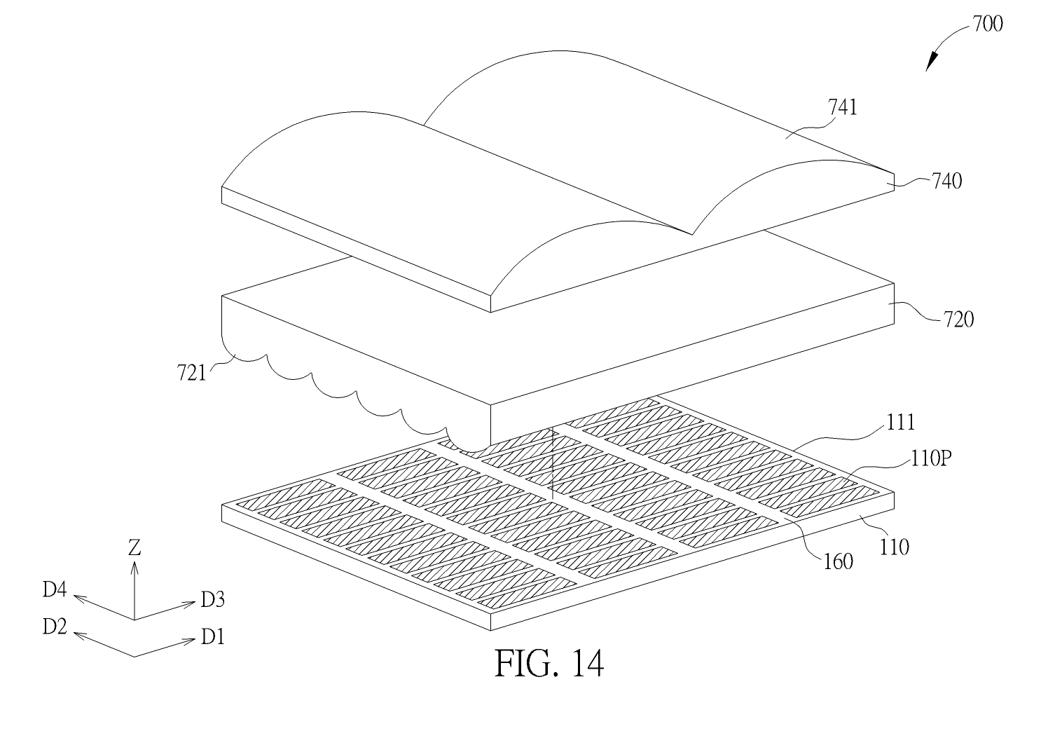

Please refer to FIG. 14. FIG. 14 is a schematic diagram illustrating a stereoscopic display device according to a fourth embodiment of the present invention. As shown in FIG. 14, a stereoscopic display device 700 is provided in the fourth embodiment of the present invention. Compared with the stereoscopic display device 100 of the aforementioned first embodiment, the first semi-cylindrical lenses 721 face the opposite direction from the second lens array 740, and the second semi-cylindrical lenses 741 face the opposite direction from the first lens array 720. In other words, the first semi-cylindrical lenses 721 face the display panel 110, while the second semi-cylindrical lenses 741 face the opposite direction from the display panel 110. Apart from the arrangement of the first semi-cylindrical lenses 721 and the second semi-cylindrical lenses 741 in the stereoscopic display device 700 of this embodiment, features, locations and material properties of other components are similar to those in the first embodiment detailed above and will not be redundantly described. It is worth noting that the stereoscopic display device 700 of the fourth embodiment has variant embodiments as the first embodiment has the first variant embodiment, the second variant embodiment and the third variant embodiment.

To sum up, because the stereoscopic display device includes the first lens array and the second lens array, the lens specifications for the portrait and landscape display modes can be designed separately so as to optimize the display quality of both the portrait and landscape display modes and provide more geometric parameters to be adjusted. Besides, because the first lens array and the second lens array are one-dimension lens arrays, the first lens array and the second lens array can be respectively formed by conventional fabrication approaches for a one-dimension lens array. By this means, not only the fabrication process is simplified but the optical geometric parameters of the first lens array and the second lens array can be precisely controlled to improve optical effects as well. Moreover, the cost is reduced and the light output efficiency is enhanced.

What is claimed is:

1. A stereoscopic display device, comprising:
a display panel, having a display surface, wherein the display panel comprises a plurality of sub-pixels arranged in an array;
a first lens array, disposed on the display surface of the display panel, wherein the first lens array is a one-dimension lens array, the first lens array comprises a plurality of first semi-cylindrical lenses extending along a first direction, and the first lens array has a first refractive index; and
a second lens array, disposed on the first lens array, wherein the second lens array is a one-dimension lens array, the second lens array comprises a plurality of second semi-cylindrical lenses extending along a second direction, the first direction is nonparallel to the second direction, and the second lens array has a second refractive index.

2. The stereoscopic display device according to claim 1, wherein each of the first semi-cylindrical lenses is a lenticular lens formed by extending a first arcuate contour along the first direction, and each of the second semi-cylindrical lenses is a lenticular lens formed by extending a second arcuate contour along the second direction.

3. The stereoscopic display device according to claim 2, wherein the first arcuate contour is a non-circular curve, and the second arcuate contour is a non-circular curve.

4. The stereoscopic display device according to claim 1, wherein each of the first semi-cylindrical lenses has a first width, and each of the second semi-cylindrical lenses has a second width.

5. The stereoscopic display device according to claim 1, wherein the first direction is perpendicular to the second direction.

6. The stereoscopic display device according to claim 1, wherein each of the sub-pixels is a rectangular sub-pixel, each of the sub-pixels has a length along a third direction, each of the sub-pixels has a width along a fourth direction, and the third direction is perpendicular to the fourth direction.

7. The stereoscopic display device according to claim 6, wherein the first direction is parallel to the fourth direction, the second direction is parallel to the third direction, the first width is at least twice the length of the sub-pixel, and the second width is at least twice the width of the sub-pixel.

8. The stereoscopic display device according to claim 6, wherein the first direction is parallel to the third direction, the second direction is parallel to the fourth direction, the first width is at least twice the width of the sub-pixel, and the second width is at least twice the length of the sub-pixel.

9. The stereoscopic display device according to claim 1, wherein the first semi-cylindrical lenses face the second lens array.

10. The stereoscopic display device according to claim 1, wherein the first semi-cylindrical lenses face the opposite direction from the second lens array.

11. The stereoscopic display device according to claim 1, wherein the second semi-cylindrical lenses face the first lens array.

12. The stereoscopic display device according to claim 1, wherein the second semi-cylindrical lenses face the opposite direction from the first lens array.

13. The stereoscopic display device according to claim 1, further comprising a support material layer disposed between the first lens array and the second lens array, the support material layer has a third refractive index, the third refractive index is less than the first refractive index, and the third refractive index is less than the second refractive index.
